(19) United States
(12) Patent Application Publication
(10) Pub. No.: US 2006/0089737 A1
(43) Pub. Date: Apr. 27, 2006

(54) Methods and systems for integrating design software modules

(75) Inventors: James Michael Forrester, Springboro, OH (US); Craig Miller Kuhne, Cincinnati, OH (US); Ruben Egberto Fairman, Forest Park, OH (US)

Correspondence Address: JOHN S. BEULICK;C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 10/961,729

(22) Filed: Oct. 8, 2004

(51) Int. Cl. G06F 19/00

(52) U.S. Cl. 700/97; 700/95

(57) ABSTRACT

A computer-implemented method for integrating a plurality of software modules using a computer having a user interface is provided, the computer including a processor and a memory. The method includes receiving data at the computer relating to a CAD part or assembly of parts, the data entered using the user interface. The data entered is stored in a predetermined location in the memory. Using the user interface, the plurality of software modules is controlled in a predetermined sequence for processing the stored data, and the data processed (output) by each module is automatically communicated with each other module.

### BACKGROUND OF THE INVENTION

This invention relates generally to computer-assisted design processes and more particularly, to systems and methods for integrating design processes.

When fabricating at least some known hardware assemblies, constructing and testing a plurality of hardware architectures and assemblies are used to finalized design parameters. Mathematical modeling and simulation have evolved to enable accurate modeling methods to be implemented using statistics and statistical methods within the modeling process. Mathematical modeling and simulation may facilitate reducing fabrication expenses and time, in comparison to constructing and testing a plurality of hardware architectures and assemblies.

However, known modeling techniques may still be a time consuming and laborious process depending on the component being fabricated. For example, when fabricating an aviation component, a plurality of external factors, such as aerodynamic, structural, and thermodynamic stresses that the component may be subjected to, are also considered. The manual procedure for executing the individual processes of the modeling method may be both time consuming and prone to error due to the amount of inter-process data manipulation required by the design engineer.

### BRIEF DESCRIPTION OF THE INVENTION

In one embodiment, a computer-implemented method for integrating a plurality of software modules using a computer having a user interface is provided, the computer including a processor and a memory. The method includes receiving data at the computer relating to a Computer Aided Design (CAD) part or assembly of parts, the data entered using the user interface. The data entered is stored in a predetermined location in the memory. Using the user interface, the plurality of software modules is controlled in a predetermined sequence for processing the stored data, and the data processed (output) by each module is automatically communicated with each other module.

In another embodiment, a computer-implemented system is provided for obtaining an optimized CAD part or assembly of parts, the system including a computer with a processor, a memory, and a user interface module. The user interface module is configured to receive data related to a CAD part or assembly of parts, store the received data to a predetermined location in the memory, control a plurality of software modules in a predetermined order for processing the stored data, and transfer automatically resulting data between the plurality of software modules.

In yet another embodiment, a computer-implemented system is provided for obtaining an optimized CAD part or assembly of parts that includes at least one client computer and at least one server computer. The client computer has a processor, a memory, and a user interface module. The server computer has a processor, a memory, and at least one of a plurality of software modules. The client computer and server computer are configured to communicate with each other. The user interface module of the client computer is configured to receive data related to a CAD part or assembly of parts and store the received data to a predetermined location in the memory of the client computer. The user interface module is also configured to control the plurality of software modules in a predetermined order for processing the stored data, and to automatically transfer resulting data between the plurality of software modules.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

### BRIEF DESCRIPTION OF THE DRAWINGS

FIG. 1 is a block diagram of an exemplary embodiment of an integrated design optimization system.

FIG. 2 is a block diagram of an exemplary data flow diagram of the integrated design optimization system shown in FIG. 1.

FIG. 3 is a flow chart of an exemplary method for integrating a plurality of application modules using the user interface shown in FIG. 2.

FIG. 4 is an exemplary embodiment of an instructions worksheet that may be requested through the user interface.

FIG. 5 is an exemplary embodiment of a setup worksheet that may be requested through the user interface.

FIG. 6 is an exemplary embodiment of an analysis regression worksheet generated by the processes shown in FIG. 3.

### DETAILED DESCRIPTION OF THE INVENTION

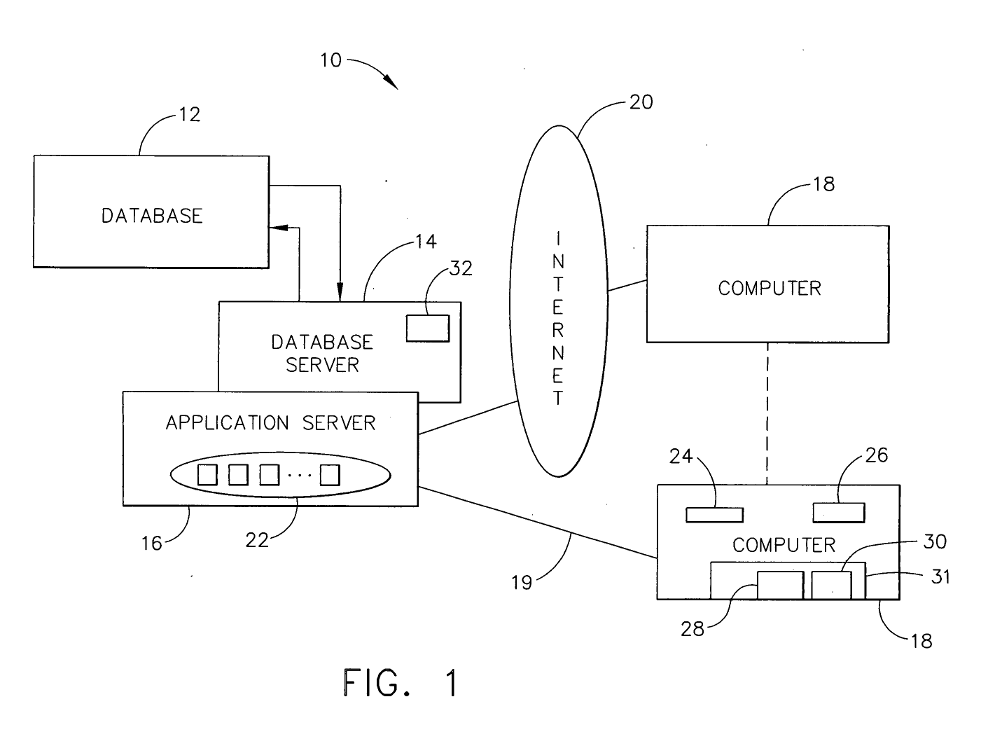

FIG. 1 is a block diagram of an exemplary embodiment of an integrated design optimization system (IDOS) 10 that includes at least one of an application server 16 and a plurality of client systems, also referred to as computers 18. Each computer 18 communicates with application server 16 directly, for example, through a local area network 19, or via an Internet 20. Application server 16 may access a database server 14 to retrieve from and store data to a database 12. Application server 16 accesses and executes a plurality of application modules 22 to perform functions of the application, e.g. aircraft engine component design. Computer 18 includes a user interface (UI) 31, a processor 24, and a memory 26. UI 31 includes a communication module 30 and a user interface module 28, each including software instructions that may be executed by processor 24. Communication module 30 enables UI 31 to communicate with application server 16 to initiate execution of modules of application modules 22 in a predefined sequence as determined by the user through UI 31. User interface module 28 communicates with the user through an input device (such as a keyboard) and an output device (such as a display screen), the input and output devices not shown in FIG. 1. Memory 26 may provide storage for intermediate results and data received from the user through UI 31. In an alternative embodiment, the functions of communication module 30 are incorporated into user interface module 28, and user interface module 28 substantially comprises UI 31.

Examples of a CAD part or assembly of parts for an aircraft engine may include an inlet duct, a compressor, a compressor blade, a turbine, a fuel injector, a combustion chamber, afterburner fuel injector, a fan, or a nozzle. An exemplary design problem related to the fabrication of these components may be to find an optimal design for the configuration of a jet engine inlet duct for a type of supersonic jet aircraft engine. Supersonic flight causes shock waves to develop in the air as the air rushes through the inlet duct. These shock waves may limit the flow of air to the jet engine compressor. However, a turbojet may reduce the limitation caused by such shock waves by adjusting the shape of the inside of the inlet duct. A design of the inlet duct may be specified with constraints on the inlet duct shape and adjustment of the shape as the speed of the aircraft changes. Invoking the modules of application modules 22 in a predetermined sequence through UI 31 may facilitate designing an optimal configuration for the inlet duct.

In an alternative embodiment, application modules 22 are distributed among a plurality of application servers 16 and UI 31 communicates with the plurality of application servers 16 to initiate the processing of application modules 22.

Database server 14 may include a Computer-Aided Design (CAD) module 32. CAD module 32 accesses data stored within database 12, for example, a CAD database 12, to store and retrieve data related to a part or assembly of parts.

In operation, a user may enter data relating to a CAD part or assembly of parts using UI 31. UI 31 stores the received data into a predetermined location in memory 26. Using UI 31, the user controls the execution of the plurality of application modules 22 in a predetermined order for processing the stored data. UI 31 automatically transfers resultant data generated by each module 22 to a subsequent one of the plurality of application modules 22. In one embodiment, user interface module 28 provides software in the form of a spreadsheet program.

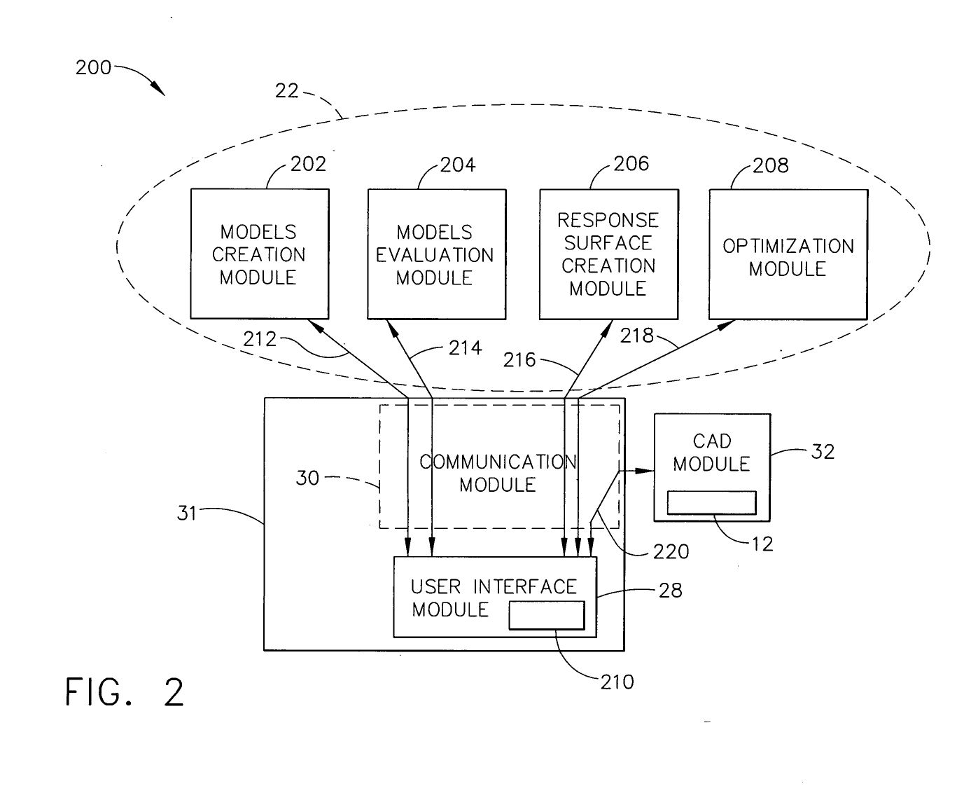

FIG. 2 is data flow diagram 200 of the exemplary embodiment IDOS 10 that may be used to integrate the plurality of application modules 22 shown in FIG. 1. Application modules 22 include a models creation (MC) module 202, a models evaluation (ME) module 204, a response surface creation (RSC) module 206, and an optimization module 208.

In operation, the user through UI 31 enters initial description and constraint data that is relevant to the design of the CAD part or assembly of parts, for example, parameters and expressions that define and constrain an inlet duct for a supersonic aircraft. The data entered is stored in memory 26 (FIG. 1). Initial description and constraint data may be entered manually through UI 31. Alternatively, UI 31 may retrieve a portion of the initial description and constraint data from CAD database 12, and store the retrieved data in memory 26. CAD module 32 retrieves the data and transmits the data through a link 220 to UI 31, and UI 31 stores the data in memory 26. Once initial description and constraint data is available in memory 26, models creation (MC) module 202 may be initiated from UI 31.

When the user uses UI 31 to initiate execution of MC module 202, initial description and constraint data may be retrieved from memory 26 and transmitted through a link 212 to MC module 202. MC Module 202 processes the initial data and creates a set of important design models (designs) for a CAD part or assembly of parts. Important design models, as used herein, are designs that are selected to systematically and efficiently evaluate component designs/models and their influence on performance allowing the evaluation of the impact of the component design parameters, their interactions and their significance. In one embodiment, MC module 202 uses a Design of Experiments (DOE) method to generate the important models. The important models created by MC module 202 (resultant data from MC module 202) are transmitted to UI 31 through link 212. UI 31 may store the important models in memory 26 or transmit the important models through link 220 to CAD module 32 for storage in CAD database 12. Once MC module 202 has created a set of important models for evaluation, execution of models evaluation (ME) module 204 may be initiated.

When the user uses UI 31 to initiate execution of ME module 204, the important models created by MC module 202 are retrieved and transmitted through a link 214 to ME module 204. ME module 204 evaluates the important models for their performance to produce a set of evaluated models for the CAD part or assembly of parts. In one embodiment, ME module 204 uses a Finite Element Analysis (FEA) method to perform the evaluations. The evaluated models (resultant data from ME module 204) are transmitted through link 214 from ME module 204 to UI 31. UI 31 may store the evaluated models in memory 26 or transmit the evaluated models through link 220 to CAD module 32 for storage in CAD database 12. Once evaluated important models are available, execution of response surface creation (RSC) module 206 may be initiated.

When the user initiates execution of RSC module 206, the evaluated important models are retrieved by UI 31 and transmitted through a link 216 to RSC module 206. RSC Module 206 uses the evaluated important models to build a Response Surface Model (RSM). An RSM is built from the evaluated important models and evaluations of models not included with the important models. RSM predictive techniques are used to determine the set of evaluations of models not included with the important models. The RSM built by RSC module 206 (resultant data from RSC module 206) is transmitted through link 216 to UI 31. UI 31 may store the RSM in memory 26 or transmit the RSM through link 220 to CAD module 32 for storage in CAD database 12. Once an RSM has been created, execution of optimization module 208 may be initiated.

When the user initiates execution of optimization module 208, the RSM is retrieved by UI 31 and transmitted through a link 218 to optimization module 208. Module 208 searches the RSM for an optimized design of the CAD part or assembly of parts. After determining the optimized design, module 208 transmits the optimized design (resultant data from module 208) through link 218 to UI 31. UI 31 may store the optimized design in memory 26 or transmit the optimized design through link 220 to CAD module 32 for storage in CAD database 12. When requested by the user, UI 31 retrieves and displays the optimal design.

In an alternative embodiment, user interface module 28 includes a spreadsheet program 210 that may be employed by the user to manually enter the initial description and constraint data for storage in memory 26. In an alternative embodiment, UI 31 may retrieve at least a portion of the initial description and constraint data for a CAD part or an assembly of parts from CAD database 12. Once the description and constraint data is manually entered and/or retrieved and stored into memory 26, the initial description and constraint data may be transmitted through links 212, 214, 216, and 218 for use by the associated modules 202, 204, 206, 208.

In one embodiment, modules 202, 204, 206, and 208 are included in application server 16 (FIG. 1), e.g. application modules 22. In another embodiment, modules 202, 204, 206, and 208 reside in a plurality of application servers 16. Computer 18 may be connected to a plurality of application servers 16 with application modules 22 distributed among the plurality of application servers 16 (not shown in FIG. 1).

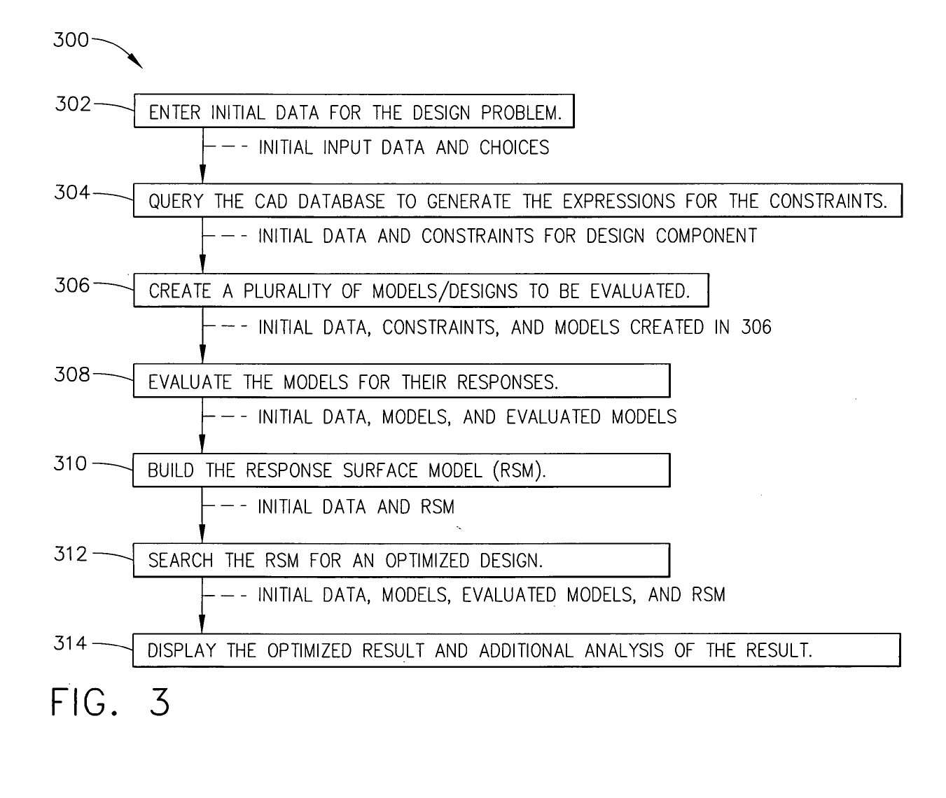

FIG. 3 illustrates an exemplary method 300 for integrating a plurality of application modules 22 using UI 31. The technical effect of IDOS 10 is an automatic transfer by UI 31 of resultant data from a module to a next module in a predetermined sequence of application modules 22 with little user effort. The technical effect (automatic transfer of resultant data) eliminates laborious, time consuming, and error prone manual manipulation of inter-process data by the design engineer. The technical effect is achieved by a user performing the set of sequential steps of method 300.

Using exemplary method 300, a user may manually enter 302, using UI 31, initial description and constraint data and/or instructs IDOS 10 to query 304 the data from data files in CAD database 12. The initial description and constraint data manually entered and/or retrieved from CAD database 12 may be stored in memory 26. The user may enter 302 a location/directory of a CAD file and a CAD file name using UI 31. IDOS 10 may use the location and CAD file name to retrieve description and constraint information from the CAD file. The user through UI 31 may also enter 302 a file name of an FEA algorithm for use by ME module 204 and/or a type of DOE for use by MC module 202. Data manually entered 302 and retrieved from query 304 of CAD database 12 may be stored in memory 26, and automatically provided to subsequent processes of method 300 by UI 31.

Initial description and constraint data includes geometrical descriptions, such as component dimensions, for example, length, height, width, and radius, that defines a size and geometry of the component. The initial data also includes constraints on the design of the component, for example, an allowable weight range, an allowable material of fabrication, and component operating constraints and conditions. The initial data describes the component using parameters, also known as independent variables. The independent variables provide a parameterized description of the component being considered for optimal design. The CAD files may supply constraints, for example equations, that restrict some parameter values when other parameter values are determined.

The user may create 306 the component designs/models to be considered using UI 31 to access MC module 202, which processes the initial description and constraint data entered 302 and queried 304. MC module 202 creates models for the component being considered. MC module 202 may use DOE methodology, which is a mathematically statistical method to efficiently generate the important models. (As used herein, important models are models that are selected to systematically and efficiently evaluate component designs/models and their influence on performance allowing the evaluation of the impact of the component design parameters, their interactions and their significance). After MC module 202 generates the important models, the important models may be stored in, for example, CAD database 12 or memory 26. In another embodiment, the generated models may be stored in a memory (not shown) associated with the application modules 22. The number of models generated by MC module 202 may depend on the number of independent variables and the type of DOE used. The important models created by MC module 202 may be automatically transmitted to the subsequent processes of method 300 by UI 31.

The user, through UI 31, commands ME module 204 to evaluate 308 the component designs/models created. Models evaluation module 204 evaluates 308 the models to produce a performance analysis for each of the models. Module 204 may evaluate 308 using an FEA method. The evaluation/performance may be viewed as a response resulting from the evaluation of the design expressions/constraints for the component when values are substituted for the independent variables that parameterize the component. [Computer time for FEA to generate the evaluation for a model may vary from a few minutes to hours or days. Computer time may not be available for evaluating 308 a relatively large number of models.] Using the DOE method in module 202 may create 306 the important models (such as a minimal set) for evaluation 308 by module 204. The evaluations resulting from module 204 may be automatically transmitted to the subsequent processes of method 300 by UI 31.

The resultant evaluations may be built 310 into a response surface (also known as a Response Surface Model (RSM)). RSC module 206 uses mathematical techniques to obtain the evaluation of models not available from MC module 202 to complete the RSM. The RSM estimates the performance (simulates an evaluation) of models not created or available from 306. RSM (simulation) is used to avoid performing a large number of FEA evaluations. The RSM built 310 by RSC module 206 may be automatically transmitted to the subsequent processes of method 300 by UI 31.

After building 310 an RSM, optimization module 208 may be accessed by UI 31 to search 312 the RSM for an optimized design for the component. Optimization module 208 searches 312 the RSM surface for an optimal design. The optimal design determined by module 208 may be automatically transmitted to the subsequent processes of method 300 by UI 31.

Optimization module 208 in combination with UI 31 displays 314 the optimized design result to the user.

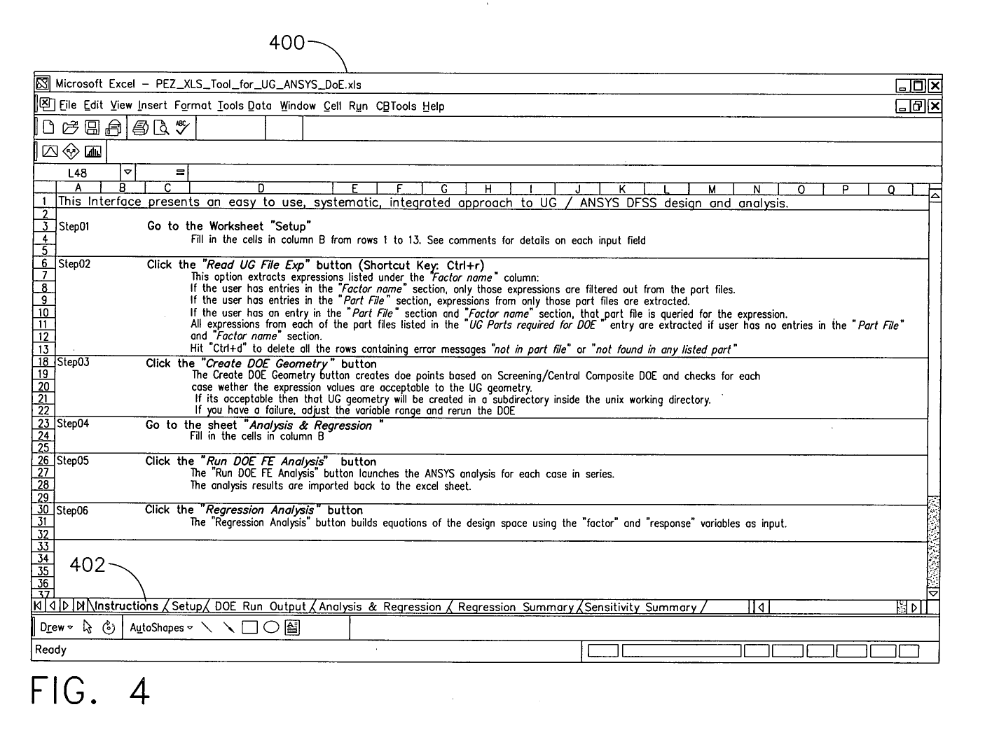

FIG. 4 is an exemplary embodiment of an instructions worksheet 400 that may be accessed using UI 31 (shown in FIG. 1). Instructions worksheet 400 may be accessible by an instructions tab 402 of spreadsheet program 210 (FIG. 2). Instructions worksheet 400 describes the steps of method 300.

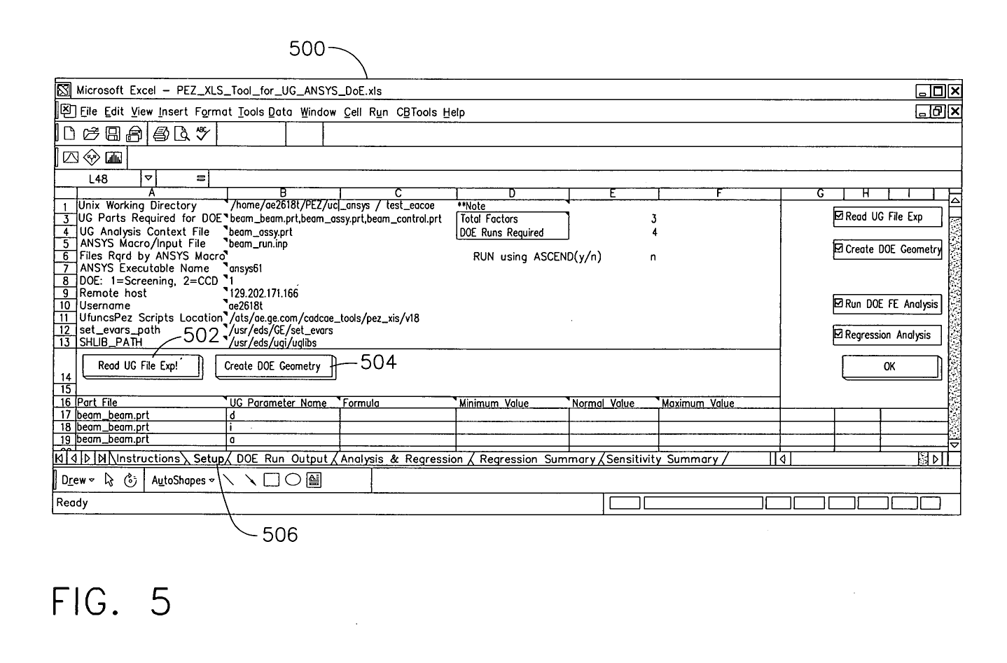

FIG. 5 is an exemplary embodiment of a setup worksheet 500 that may be accessed through UI 31. Setup worksheet 500 is accessed by a setup tab 506 of application spreadsheet program 210. The user uses setup worksheet 500 to enter 302 (FIG. 3) initial description and constraint data and query 304 (FIG. 3) for the initial data. The user selects the type of DOE desired and whether distributed computing resources (parallel computing) are to be used for the DOE and FEA analyses. A read file button 502 is provided for querying 304 the CAD database 12 for initial description and constraint data. A create DOE button 504 accesses DOE processing (MC module 202) to create the models.

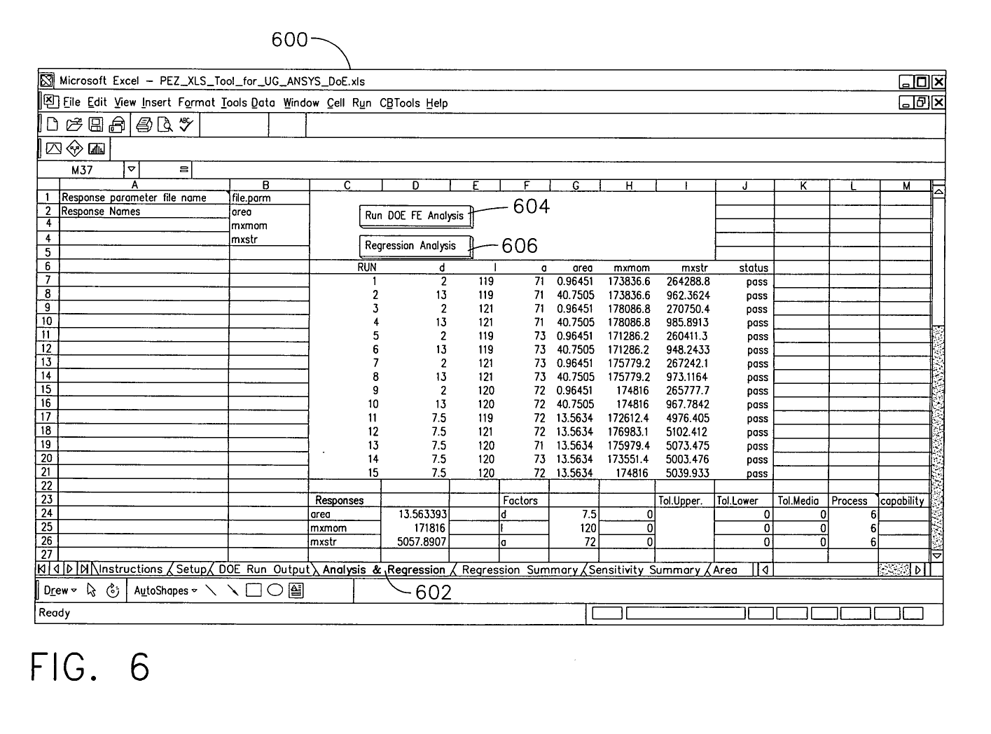

FIG. 6 is an exemplary embodiment of an analysis regression worksheet 600 illustrating data generated by 306, 308, 310, and 312 of FIG. 3. An analysis regression tab 602 of application spreadsheet program 210 is selected to select regression worksheet 600. The user accesses the FEA to produce the responses for the DOE generated models by selecting a run FE button 604. When the FEA has completed processing and responses are available for all the DOE generated models, the user selects a run analysis button 606 to create an RSM. UI 31 then automatically inserts pertinent constraint information from 302 and 304 into optimization software of optimization module 208 that searches 312 for an optimized design for the component.

Spreadsheet program 210 may include a plurality of additional worksheets (not shown). User interface tabs may be used to select the additional worksheets for viewing the data of regression summary and sensitivity summary worksheets. These worksheets include regression modeling fit statistics and design factor vs. response sensitivity statistics. User interface tabs may be used to select from a plurality of charts illustrating regression fit residuals, “actual” vs. “predicted” values, residual vs. “predicted” values, and percent error vs. “predicted” values. The use of user interface tabs by UI 31 is exemplary only, for example, another form of UI 31 may be provided by drop down menus instead of user interface tabs.

While the invention has been described in terms of various specific embodiments, those skilled in the art will recognize that the invention can be practiced with modification within the spirit and scope of the claims.

What is claimed is:

1. A computer-implemented method for integrating a plurality of software modules using a computer having a user interface, the computer including a processor and a memory, said method comprising:
receiving data at the computer relating to a Computer Aided Design (CAD) part or assembly of parts, the data entered using the user interface;
storing the received data in a predetermined location in the memory;
using the user interface, controlling the plurality of software modules in a predetermined sequence for processing the stored data; and
automatically communicating data processed by each module with each other module in the sequence using the user interface.

2. A method in accordance with claim 1 wherein transferring the processed data between the plurality of software modules comprises:
receiving the processed data from a module;
storing the processed data with stored data in the predetermined location in the memory to determine a resultant data in the predetermined location in the memory;
retrieving the resultant data from the predetermined-location within the memory; and
communicating the resultant data to a next one of the plurality of software modules in the predetermined sequence.

3. A method in accordance with claim 1 further comprising storing the processed data to a respective memory associated with at least one of the plurality of software modules.

4. A method in accordance with claim 3 wherein said transferring resulting data between the plurality of software modules comprises:
retrieving the resulting data from the at least one of a predetermined location of a memory associated with at least one of the plurality of software modules; and
transmitting the resulting data to a next one of the plurality of software modules in a predetermined order.

5. A method in accordance with claim 1 wherein said receiving data related to a CAD part or assembly of parts comprises receiving at least one part parameter, a limit of an allowable range of value for the part parameter, a design constraint of a part, and a location of files that include information relating to processing the plurality of software modules.

6. A method in accordance with claim 1 wherein said receiving data related to a CAD part or assembly of parts comprises receiving data via the user interface, the user interface including an application spreadsheet program.

7. A method in accordance with claim 1 wherein said using the user interface to control the plurality of software modules comprises initiating the processing of a Computer Aided Design (CAD) module.

8. A method in accordance with claim 1 wherein said using the user interface to control the plurality of software modules comprises initiating the processing of a models creation module to generate a set of designs.

9. A method in accordance with claim 1 wherein said using the user interface to control the plurality of software modules comprises initiating a models evaluation module to evaluate a set of designs.

10. A method in accordance with claim 1 wherein said using the user interface to control the plurality of software modules comprises initiating a response space creation module which uses an evaluated set of designs to create a Response Surface Model (RSM).

11. A method in accordance with claim 1 wherein said using the user interface to control the plurality of software modules comprises initiating an optimization/results module which searches an RSM to find an optimized design.

12. A computer-implemented system for obtaining an optimized CAD part or assembly of parts, said system comprising:
a computer comprising a processor, a memory, and a user interface module; and
the user interface module configured to:
receive data related to a CAD part or assembly of parts;
store the received data to a predetermined location in the memory;
control a plurality of software modules in a predetermined order for processing the stored data; and
automatically transfer resulting data between the plurality of software modules.

13. A computer-implemented system in accordance with claim 12 wherein said user interface module comprises an application spreadsheet program.

14. A computer-implemented system in accordance with claim 12 wherein the plurality of software modules includes a Computer Aided Design (CAD) module.

15. A computer-implemented system in accordance with claim 12 wherein the plurality of software modules includes at least one of a models creation module that generates a set of designs, a models evaluation module that evaluates the generated set of designs, a response space creation module that creates a Response Surface Model (RSM) from the evaluation of the generated set of designs, and an optimization/results module that searches the RSM to find an optimized design.

16. A computer-implemented system for obtaining an optimized CAD part or assembly of parts, said system comprising:
at least one client computer comprising a processor, a memory, and a user interface module, said at least one client computer capable of communicating with at least one server computer;
the at least one server computer comprising a processor, memory, and at least one of a plurality of software modules, said at least one server computer capable of communicating with said at least one client computer; and
the user interface module configured to:
receive data related to a CAD part or assembly of parts;
store the received data to a predetermined location in the memory of said at least one client computer;
control the plurality of software modules in a predetermined order for processing the stored data; and
automatically transfer resulting data between the plurality of software modules.

17. A computer-implemented system in accordance with claim 16 wherein said user interface module comprises an application spreadsheet program.

18. A computer-implemented system in accordance with claim 16 wherein the plurality of software modules includes a Computer Aided Design (CAD) module.

19. A computer-implemented system in accordance with claim 16 wherein the plurality of software modules includes at least one of a models creation module that generates a set of designs, a models evaluation module that evaluates the generated set of designs, a response space creation module that creates a Response Surface Model (RSM) from the evaluation of the generated set of designs, and an optimization/results module that searches the RSM to find an optimized design.

20. A computer-implemented system in accordance with claim 16 wherein said at least one client computer and said at least one server computer communicate via the Internet.
